(19) United States
(12) Patent Application Publication
(10) Pub. No.: US 2014/0163529 A1
(43) Pub. Date: Jun. 12, 2014

(54) Adapter For A Feeding Tube

(71) Applicant: Indiana University Research & Technology Corporati, Indianapolis, IN (US)

(72) Inventors: Boaz Karmazyn, Indianapolis, IN (US); Sally M. Powell, Indianapolis, IN (US)

(73) Assignee: Indiana University Research & Technology Corporati, Indianapolis, IN (US)

(21) Appl. No.: 14/102,074

(22) Filed: Dec. 10, 2013

Related U.S. Application Data
(60) Provisional application No. 61/735,083, filed on Dec. 10, 2012.

(51) Int. Cl. A61J 15/00

(52) U.S. Cl. CPC A61J 15/0026
USPC 604/535

(57) ABSTRACT

A feeding tube adapter includes two detachable members. Each member is fluidly connected to one of two feeding tubes that supply fluid from a feed source to a patient. When attached, the feeding tube adapter enables fluid to flow from the feed source to the patient. When detached, the feeding tube adapter reduces or eliminates leakage of fluid from the fluid source. A force that detaches the feeding tube adapter is less than a force that removes a section of feeding tube from within the patient.

### CLAIM OF PRIORITY

This application claims priority to U.S. Provisional Application No. 61/735,083, which is entitled “Adapter for a Feeding Tube,” and was filed on Dec. 10, 2012.

### TECHNICAL FIELD

This disclosure relates generally to tubes used to deliver liquid food and medicine to a patient, and more particularly to the connection of a feeding tube to a patient.

### BACKGROUND

Some patients have medical conditions that preclude the normal ingestion and digestion of food. To provide nutrition and medicine to these patients, a healthcare provider may insert a feeding tube directly into the digestive tract of the patient. A nasogastric feeding tube (NG) tube is inserted through the nostrils and extends down the esophagus to the stomach. NG tubes, however, are typically used only for comparatively short periods of time.

For long-term feeding, common surgical procedures insert either a gastric feeding tube (G tube) or a jejunal feeding tube (J tube). The G tube is inserted through an incision (stoma), referred to as a gastrostomy, through the abdomen and into the stomach. In some instances, the J tube is inserted through another abdominal stoma, referred to as a jejunostomy, directly into the jejunum of the small intestine. In other instances, the J tube is inserted through a gastrostomy into the stomach and then fed through the small intestine until a distal end of the J tube is located in the jejunum.

Another type of feeding tube is referred to as a gastric-jejunal (GJ) tube that that extends through both the stomach and jejunum. In a GJ tube, two separate inlet ports enable administration of fluid to both the stomach and jejunum through separate outlets that are positioned in the stomach and jejunum.

Upon insertion of a feeding tube, such as a GJ tube, a feeding source provides fluid nutrition and/or medicine to the patient through the GJ tube. The end of the GJ tube that is inserted into the patient is typically held in place with either an inflatable member, referred to as a “balloon,” or with a retention dome.

FIG. 5 depicts a prior art G-tube configuration in which a feeding source 704 supplies fluid to a tube 708 that extends through a stoma 716 into the stomach of a patient. The feeding source is typically a plastic bag holding fluid. The plastic bag is suspended above the level of the stoma and the fluid flows through the tube 708 to the patient under the force of gravity. A port 712 is inserted into the stoma to hold the stoma open and provide a clear path for the feeding tube 708. The distal end of the feeding tube 720 is open to enable liquid from the feeding source 704 to enter the stomach. A balloon 724 is attached is positioned within the patient proximate to the interior opening of the stoma to hold the feeding tube 704 in place within the stomach.

One difficulty in providing long-term feeding through a GJ tube occurs when an external force pulls on the GJ tube. When the force of the pull is comparatively small, the balloon 724 or other anchor mechanism can hold the GJ tube in place. Often, however, a strong pull on the GJ tube pulls the entire GJ tube out through the stoma. Some patients may pull the GJ tube out intentionally, or the GJ tube may be pulled out accidentally when a patient falls or trips over the GJ tube. When the distal end of the GJ tube is pulled out of the stoma, a new GJ tube must be reinserted. When removed, the patient may not receive important nutrition or medication that is supposed to be delivered through the GJ tube. The patient often experiences discomfort or other negative health effects due to the sudden interruption of the delivery of nutrition or medication. Some feed sources, such as those used in fluoroscopy, also include radioactive material that may leak and contaminate the patient and healthcare personnel when the GJ tube is removed. Reinsertion of the GJ tube may further require a fluoroscopy-guided procedure that is typically performed by a skilled radiologist. Many hospitals do not have the staff or facilities needed to perform these procedures, and an unscheduled reinsertion of the GJ tube can be time consuming, uncomfortable, and costly for the patient. Consequently, improvements to feeding tubes to prevent undesirable removal of the GJ tube from the patient and to prevent leakage of fluid from the feed source would be beneficial.

### SUMMARY

In one embodiment, an adapter feeding tubes has been developed. The adapter includes a first adapter member, and a second adapter member. The first adapter member can include a first engagement member configured to fluidly couple the first adapter member to a first feeding tube extending from a patient, a first lumen formed within the first adapter member, and a first retention member formed on the first adapter member along a length of the first lumen.

The second adapter member can include a second engagement member configured to fluidly couple the second adapter member to a second feeding tube extending from a feed source, a second lumen formed within the second adapter member and having a diameter corresponding to an outer diameter of the first adapter member, a second retention member formed on the second adapter, member along a length of the second lumen, the second retention member being configured to engage the first retention member in response to the first adapter member being inserted into the second lumen, and a resealable member attached to a first end of the second lumen. The resealable member is moveable between a first position and a second position, the resealable member to form a seal across a diameter of the second lumen in the first position and to unseal the second lumen in the second position.

These and other advantages, effects, features and objects of the invention will become better understood from the description that follows. In the description, reference is made to the accompanying drawings, which form a part hereof and in which there is shown by way of illustration, not limitation, embodiments of the invention.

### BRIEF DESCRIPTION OF THE DRAWINGS

The advantages, effects, features and objects other than those set forth above will become more readily apparent when consideration is given to the detailed description below. Such detailed description makes reference to the following drawings, wherein:

FIG. 1 is a cross-sectional view of two components that form a detachable feeding tube adapter.

FIG. 2 is a cross-sectional view of a sealing member that prevents leakage of fluid from a feed source when the detachable feeding tube adapter is disconnected.

FIG. 3A is a cross-sectional view of the detachable feeding tube adapter of FIG. 1 connected in a first configuration.

FIG. 3B is a cross-sectional view of the detachable feeding tube adapter of FIG. 1 connected in a second configuration.

FIG. 3C is a cross-sectional view of the detachable feeding tube adapter of FIG. 1 connected in a third configuration.

FIG. 4 is a cross-sectional view of the detachable feeding tube adapter of FIG. 1 when fluidly coupled to prior art feeding tubes.

FIG. 5 is a prior art depiction of a gastronomic feeding tube inserted into the stomach of a patient.

While the invention is susceptible to various modifications and alternative forms, exemplary embodiments thereof are shown by way of example in the drawings and are herein described in detail. It should be understood, however, that the description of exemplary embodiments is not intended to limit the invention to the particular forms disclosed, but on the contrary, the intention is to cover all advantages, effects, features and objects falling within the spirit and scope of the invention as defined by the embodiments above and the claims below. Reference should therefore be made to the embodiments above and claims below for interpreting the scope of the invention. As such, it should be noted that the embodiments described herein may have advantages, effects, features and objects useful in solving other problems.

### DETAILED DESCRIPTION

The systems and methods now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements.

Likewise, many modifications and other embodiments of the systems and methods described herein will come to mind to one of skill in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

Unless defined otherwise, all technical and scientific terms used herein have the same meaning as commonly understood by one of skill in the art to which the invention pertains. Although any methods and materials similar to or equivalent to those described herein can be used in the practice or testing of the present invention, the preferred methods and materials are described herein.

Moreover, reference to an element by the indefinite article “a” or “an” does not exclude the possibility that more than one element is present, unless the context clearly requires that there be one and only one element. The indefinite article “a” or “an” thus usually means “at least one.”

### Overview

The description below and the accompanying figures provide a general understanding of the environment for the system and method disclosed herein as well as the details for the system and method. In the drawings, like reference numerals are used throughout to designate like elements.

As used herein, the term “feed source” refers to any supply of fluid that is provided to a patient through one or more feeding tubes. One example of a feed source is a fluid bag that is positioned above a patient and that provides fluid to the patient through a feeding tube under the force of gravity

As used herein, the terms “tension” and “tensile force” refer to a tension force acting on two connected members that pulls the members apart. A “tensile strength” of a physical connection refers to an amount of tensile force that the connection accepts before the members separate under the tensile force.

As used herein, the term “seal” refers to any member that either slows or prevents a flow of fluid through a tube. In the context of a feeding tube, a seal slows or prevents leakage of fluid from one end of a feeding tube section when the seal is closed. When the feeding tube is unsealed, fluid flows through the feeding tube. Various embodiments of an adapter that seals a free end of a feeding tube when the feeding tube is not connected to a patient to prevent leaks and unseals when connected to the patient to enable the feeding tube to provide fluid are described below.

### Systems and Methods

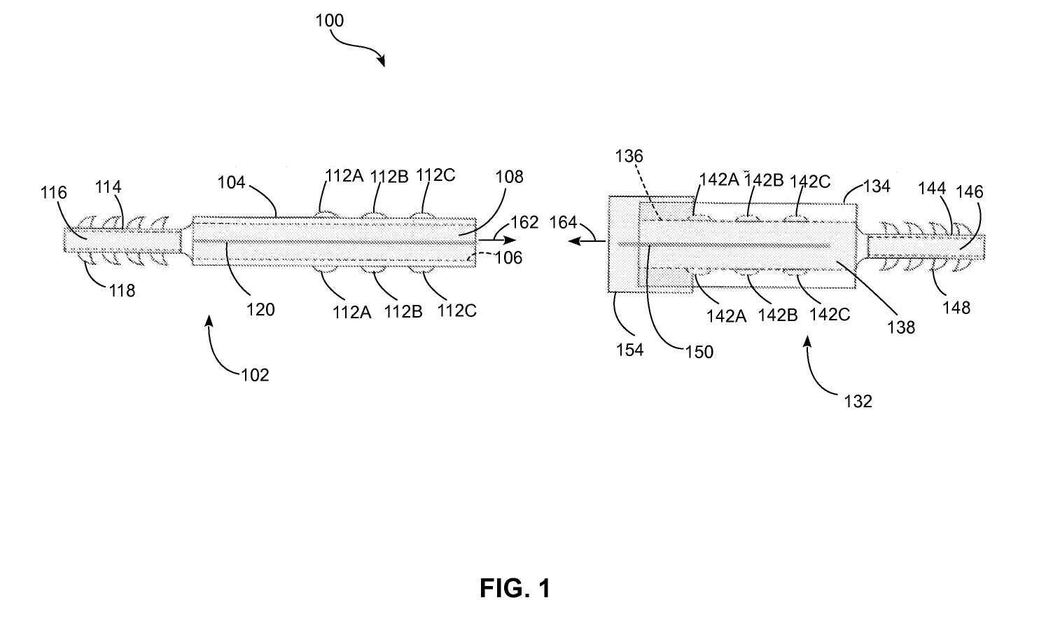

FIG. 1 depicts a feeding tube adapter 100. The feeding tube adapter 100 includes a first port 102 that is configured to engage a length of feeding tube that is fluidly coupled to the patient, and a second port 132 that is configured to engage another length of feeding tube that is fluidly coupled to one or more feeding sources. In the configuration of FIG. 1, the first port 102 and second port 132 are disconnected from each other. The first port 102 and second port 132 are pushed together as indicated by arrows 162 and 164 to insert a first adapter member 104 in the first port 102 into a lumen 138 formed in a second adapter member 134 in the second port 132.

The first port 102 includes a feeding tube engagement member 114 and a first adapter member 104. The feed tube engagement member 114 includes an engagement lumen 116 that is fluidly coupled to a length of feeding tube extending from the patient. A plurality of barbs 118 extend outwardly from the engagement member 114. The barbs 118 include curved projections that extend in direction 162 from the engagement member 114. The barbs 118 enable insertion of the feeding tube engagement member 114 into a lumen of a feeding tube. Once inserted into the lumen of the feeding tube, the barbs 118 engage an inner surface of the feeding tube and secure the first port 102 to the end of the feeding tube. Thus, the engagement member 114 secures the first port 102 to one end of a feeding tube and fluidly couples the first port 102 to the feeding tube.

In the port 102, the first adapter member 104 includes a tubular wall that forms a lumen 108. The lumen 108 is fluidly coupled to the engagement lumen 116 to enable fluid to flow through the first port 102. As depicted in FIG. 1, a diameter of the lumen 108 is greater than a diameter of the engagement lumen 116. In alternative configurations, the engagement lumen 116 and lumen 108 in the adapter member 104 have substantially the same diameter, or the diameter of the engagement lumen 116 is greater than the diameter of the lumen 108. When the first port 102 is fluidly coupled to the second port 132, fluid flows through the lumen 108, engagement lumen 116, and a feeding tube connected to the patient.

The first adapter member 104 includes a plurality of retention members 112A-112C that extend outwardly from the outer surface of the first adapter member 104. The retention members 112A-112C are approximately hemispherical projections that are arranged linearly along the length of the first adapter member 104 on two opposing sides of the first adapter member 104. Alternative embodiments include different configurations of the retention members, including annular retention members that circumscribe the first adapter member 104, a single projection in each set of retention members, or groups of three or more projections in each set of retention members. A retention member may extend inwardly from the outside of the first adapter member 104 instead of projecting outwardly. In another configuration, each set of retention members is offset by a predetermined angle from the remaining retention members instead of being arranged in the linear configuration of FIG. 1. While the first adapter 104 includes three sets of retention members 112A-112D, alternative embodiments may include fewer or greater numbers of projection members. As described below, the magnitude of tensile force that disconnects the first port 102 and second port 132 is configurable based on the number of retention members that engage corresponding receptacles in the second port 132.

In the adapter 100, the second port 132 includes a feeding tube engagement member 144 and a second adapter member 134. The feed tube engagement member 144 includes an engagement lumen 146 that is fluidly coupled to a length of feeding tube that extends from a feed source. A plurality of barbs 148 extend outwardly from the engagement member 144. The barbs 148 include curved projections that extend in direction 164 from the engagement member 144. The barbs 148 enable insertion of the feeding tube engagement member 144 into a lumen of a feeding tube. Once inserted into the lumen of the feeding tube, the barbs 148 engage an inner surface of the feeding tube and secure the second port 132 to the end of the feeding tube. Thus, the engagement member 144 secures the second port 132 to one end of a feeding tube and fluidly couples the second port 132 to the feeding tube.

In the embodiment of adapter 100, the feeding tube engagement members 114 and 134 have similar configurations to enable the adapter 100 to engage two different feeding tubes, or two segments of a single feeding tube that is cut into two segments for insertion of the adapter 100. In another embodiment, the feeding tube engagement members 114 and 134 may be configured to engage feeding tubes having different diameters to enable the adapter 100 to provide a detachable fluid coupling between feeding tubes having different diameters.

In the second port 132, the second adapter member 134 forms a lumen 138. The lumen 138 is fluidly coupled to the engagement lumen 146 to enable fluid from a feeding tube to flow through the engagement member 144 and into the second adapter member 134. As depicted in FIG. 1, a diameter of the lumen 138 is greater than a diameter of the engagement lumen 146. In alternative configurations, the engagement lumen 146 and lumen 138 in the second adapter member 134 have substantially the same diameter, or the diameter of the engagement lumen 146 is greater than the diameter of the lumen 138.

The second adapter member 134 includes a plurality of retention receptacles 142A-142C formed in an interior surface 136 of the of the second adapter member 134. The retention receptacles 142A-142C are positioned and shaped to engage at least one of the retention members 112A-112C formed on the first adapter member 102. The retention receptacles 142A-142C enable the first port 102 to engage the second port 132 in multiple distinct configurations. In some embodiments, the retention receptacles 142A-142C and corresponding retention members 112A-112C generate an audible click or tactile response to indicate that the ports 102 and 132 are fluidly connected. Alternative embodiments of the second port 132 include different configurations of the retention receptacles that engage alternative embodiments of the retention members in the first port 102. In other embodiments, the second adapter member 134 includes one or more retention members that project into the lumen 138 and engage corresponding retention receptacles formed in the first adapter member 104.

The second port 132 is configured to engage a feed source to provide fluid from the feed source to the first port 102 when the two ports are connected, and to prevent fluid from leaking from the second port 132 when the two ports are disconnected. A resealable member 154 is attached to the end of the second adapter member 134 opposite the feeding tube engagement member 114. The resealable member 154 is formed from a resilient material such as silicone rubber. In the configuration of FIG. 1, the resealable member 154 seals an open end of the lumen 138 and slows or prevents a flow of fluid from a feed source through the lumen 138. Thus, the resealable member 154 prevents leaks when the second port 132 is disengaged from the first port 102.

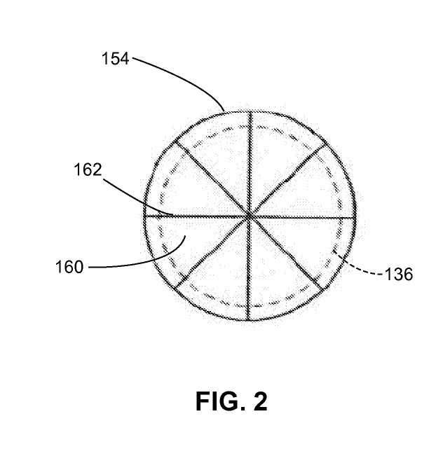

FIG. 2 depicts a front view of the resealable member 154. The dashed circle 136 indicates the inner diameter of the lumen 138 in the second port 132. In the example of FIG. 2, the resealable member 154 is formed from eight sections 160 that engage each other along edges 162. In the configuration of FIG. 1, the eight sections 160 seal the lumen 138 and slow or prevent fluid from leaking out of the second port 132. When the first port 102 is connected to the second port 132, the first adapter member 104 pushes sections 160 inward toward the inner surface 136 of the lumen 138. The lumen 138 is unsealed and is placed in fluid communication with the lumen 108 in the first port 102. When the first port 102 detaches from second port 132, the sections 160 return to the configuration of FIG. 2 to reestablish a seal across the lumen 138.

The first port 102 and second port 132 include alignment markings 120 and 150, respectively. The alignment markings 120 and 150 are visible indicia formed on the external surface of both the first adapter member 104 and second adapter member 134. In some embodiments, the alignment markings are colored lines that are easily visible to a person using the feeding tube adapter 100. In the adapter 100, the alignment markings form an unbroken line when the retention members 112A-112C are in linear alignment with the retention receptacles 142A-142C. Use of the alignment markings enables efficient identification of the rotational orientation of the first port 102 and second port 132 to align the retention members 112A-112C with the retention receptacles 142A-142D during connection of the first port 102 and second port 132. Some embodiments that have retention members positioned with different angular offsets in first port 102 include multiple sets of alignment markings arranged around the periphery of the first adapter member 104 and second adapter member 134. Multiple alignment markings enable alignment of different retention members and receptacles to connect the feeding tube adapter with the desired tensile strength.

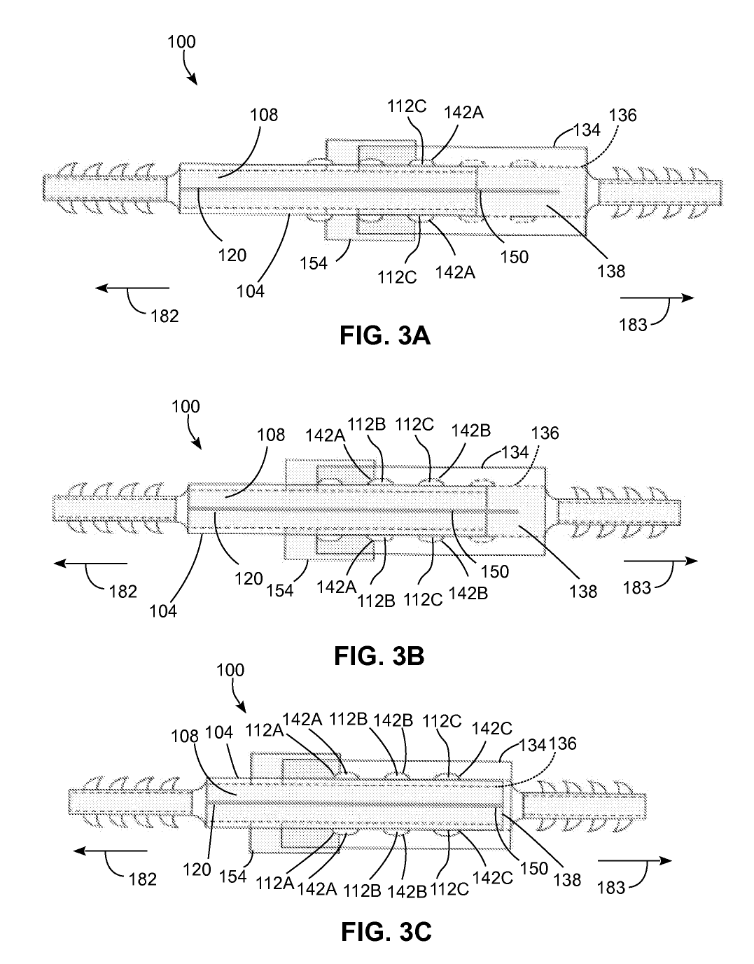

FIGS. 3A-3C depict three configurations of the adapter 100 with the first port 102 fluidly connected to the second port 132. In FIG. 3A, the first adapter member 104 engages the second adapter member 134 with retention members 112C engaging retention receptacles 142A. In FIG. 3B, the first adapter member 104 engages the second adapter member 134 with retention members 112B and 112C engaging retention receptacles 142A and 142B, respectively. In FIG. 3C, the first adapter member 104 engages the second adapter member 134 with retention members 112A, 112B and 112C engaging retention receptacles 142A, 142B and 142C, respectively.

In each of FIGS. 3A-3C, a portion of the first adapter member 104 is inserted into the lumen 138 of the second adapter member 132. The first adapter member 104 unseals the resealable member 154, and the lumen 108 is placed in fluid communication with the lumen 138. The outer diameter of the first adapter member 104 corresponds to the diameter of the inner surface 136 of the second adapter member 134 to prevent fluid in the lumen 138 from leaking around the exterior of the first adapter member 104. The feeding tube adapter 100 fluidly connects a first feeding tube connected to the first port 102 to a second feeding tube connected to the second port 132 in each of configurations of FIGS. 3A-3C.

The tensile strength of the connection between the first port 102 and second port 103 increases progressively from the configuration of FIGS. 3A-3C. For example, in FIG. 3A, a single set of retention members 112C engages the retention receptacles 142A. A tensile force, indicated by arrows 182 and 183, overcomes friction between the single set of retention members 112C and retention receptacles 142A to disconnect the feeding tube adapter 100. In FIG. 3B, a tensile force that is sufficient to disconnect the feeding tube adapter overcomes friction between retention members 112B-112C and corresponding retention receptacles 142A-14B. In FIG. 3C, a tensile force overcomes friction between three sets of retention members 112A-112C and corresponding retention receptacles 142A-142C. Additionally, the surface area of the first adapter member 104 that engages the inner surface 136 of the second adapter member 134 increases as the first adapter member 104 extends progressively further into the lumen 138 in FIGS. 3A-3C. Consequently, the tensile strength of the adapter 100 increases as the number of retention projections that engage retention receptacles increases, and as the surface area of the first adapter member 104 that engages the second adapter member 134 increases. In one embodiment, the minimum tensile force that disconnects the adapter 100 is approximately 2 Newtons, 5 Newtons, and 9 Newtons in the configurations of FIGS. 3A-3C, respectively. The tensile strength of the connection in the feeding tube adapter 100 is selected to be less than a tensile force that could dislodge a feeding tube from the jejunum and/or stomach of the patient, due to either accidental or intentional pulling of the feeding tube.

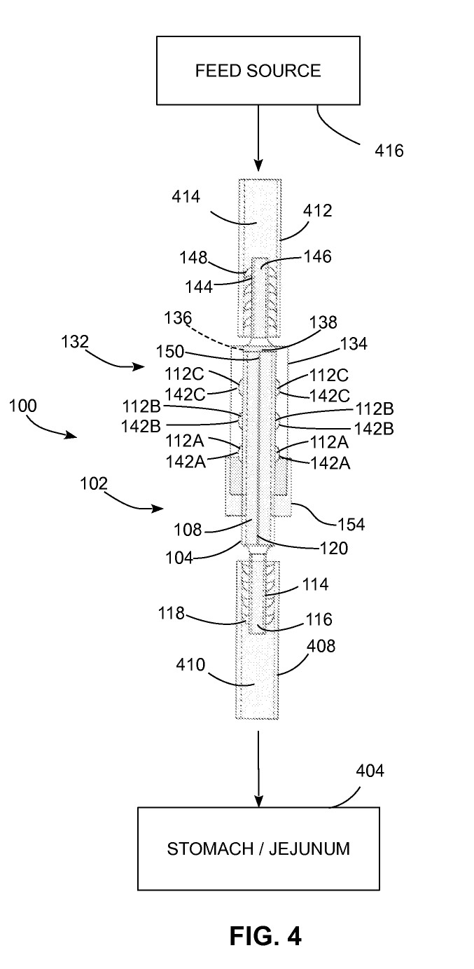

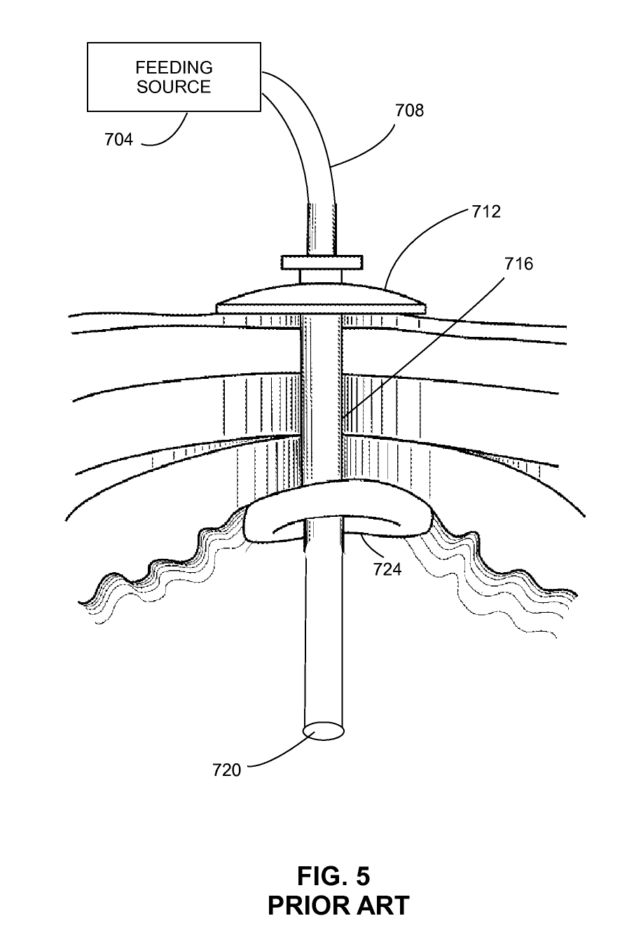

FIG. 4 depicts the feeding tube adapter 100 connecting a feed source 416 to a GJ feeding tube that extends into the stomach and jejunum 404 of a patient. In FIG. 4, a first length of feeding tube 408 is fluidly connected to the first port 102 and a second length of feeding tube 412 is fluidly connected to the second port 132. In the example of FIG. 4, the feeding tubes 408 and 412 are prior art feeding tubes. The feeding tube adapter 100 is introduced by, for example, cutting a single prior art feeding tube at a location between the stoma leading to the stomach and jejunum 404 and the feed source 416. The two sections of the feeding tube are then attached to the engagement members 114 and 144 in the feeding tube adapter 100. Thus, the feeding tube adapter 100 is suitable for use in a wide range of existing feeding tube arrangements, including percutaneous gastrostomy (PEG) tube, and “low-profile” feeding tube arrangements. In one embodiment, the feeding tube segment 408 extends several centimeters from the stoma to engage the feeding tube adapter 100. The feeding tube segment 412 extends for a longer length to the feed source 416.

In FIG. 4, fluid flows from the feed source 416 through a lumen 414 in the first segment of feeding tube 412, through the lumens 146 and 138 in the second port 132, lumens 108 and 116 in the first port 102, and then through a lumen 410 in the feeding tube 408. In various embodiments, the feeding tube 408 extends directly into the stomach and jejunum 404, or connects to another fluid coupling that is located proximate to the stoma. In the example of FIG. 4, the feeding tube adapter is connected in the configuration of FIG. 3C with the retention members 112A-112C engaging retention receptacles 142A-142C, respectively. The feeding tube adapter 100 may, however, also be configured with the configurations of FIG. 3A or FIG. 3B to provide a fluid path between the feed source 416 and the stomach/jejunum 404.

The feeding tube adapter 100 remains secured in the configuration of FIG. 4 during normal operation. If, however, a tensile force exerted on the feeding tube adapter 100 exceeds the configured tensile strength, then the first port 102 and second port 132 separate and the feeding tube segment 408 disconnects from the feeding tube segment 412. The resealable member 154 seals the lumen 138 when the second port 132 disconnects from the first port 102, and the resealable member 154 prevents leakage of fluid from the feed fluid source 416. The feeding tube adapter 100 is subsequently reconnected to resume the flow of fluid from the feed source 416 to the stomach and jejunum 404 with minimal interruption to the delivery of fluid to the patient. Because the adapter 100 disconnects in response to a lower tensile force than is required to dislodge the feeding tube segment 408, the sections of the feeding tube within the patient remain securely in place in the event of an accidental or intentional pull on the feeding tube.

The present invention has been described in connection with what are presently considered to be the most practical and preferred embodiments. However, the invention has been presented by way of illustration and is not intended to be limited to the disclosed embodiments. Accordingly, one of skill in the art will realize that the invention is intended to encompass all modifications and alternative arrangements within the spirit and scope of the invention as set forth in the appended claims.

What is claimed is:

1. A feeding tube adapter comprising:
a first adapter member, the first adapter member comprising:
a first engagement member configured to fluidly couple the first adapter member to a first feeding tube;
a first lumen formed within the first adapter member;
a first retention member formed on the first adapter member along a length of the first lumen;
a second adapter member, the second adapter member comprising:
a second engagement member configured to fluidly couple the second adapter member to a second feeding tube extending from a feed source;
a second lumen formed within the second adapter member, the second lumen having a diameter corresponding to an outer diameter of the first adapter member;
a second retention member formed on the second adapter member along a length of the second lumen, the second retention member being configured to engage the first retention member in response to the first adapter member being inserted into the second lumen; and
a resealable member attached to a first end of the second lumen and moveable between a first position and a second position, the resealable member forming a seal across a diameter of the second lumen in the first position, and unsealing the second lumen in the second position.

2. The feeding tube adapter of claim 1 wherein the first adapter member is configured to move the resealable member from the first position to the second position in response to the first adapter member being inserted into the second lumen, the resealable member being configured to return to the first position in response to the first adapter member being removed from the second lumen.

3. The feeding tube adapter of claim 1 further comprising:
a first plurality of retention members formed on the first adapter member along the length of the first lumen; and
a second plurality of retention members formed on the second adapter member along the length of the second lumen, the first plurality of retention members being configured to engage the second plurality of retention members in a first configuration in response to a first portion of the first adapter member being inserted into the second lumen, and the first plurality of retention members being configured to engage the second plurality of retention members in a second configuration in response to the first portion of the first adapter member and a second portion of the first adapter member being inserted into the second lumen.

4. The feeding tube adapter of claim 1, wherein the first adapter member and second adapter member are configured to detach in response to a first tensile force being applied to the second feeding tube, the first tensile force being less than a tensile force that is effective to dislodge the first feeding tube from the patient.

5. The feeding tube adapter of claim 1 further comprising:
a projection from an outer surface of the first adapter member; and
a receptacle in the second retention member that is formed in an inner surface of the second lumen.

6. The feeding tube adapter of claim 1, wherein the resealable member is essentially comprised of silicone rubber.

7. The feeding tube adapter of claim 1 further comprising:
a first visible indicator formed on an exterior of the first adapter member; and
a second visible indicator formed on an exterior of the second adapter, the first visible indicator and second visible indicator being configured to indicate an alignment between the first retention member and the second retention member.

8. The feeding tube adapter of claim 1 further comprising:
at least one hemispherical projection on the first retention member; and
at least one hemispherical receptacle on the second retention member that corresponds to the at least one hemispherical projection on the first retention member.

9. The feeding tube adapter of claim 1 further comprising:
an annular projection formed around a circumference of the first adapter member; and
an annular receptacle formed on the second retention member that corresponds to the annular projection on the first adapter member.
